(19) United States
(12) Patent Application Publication
(10) Pub. No.: US 2025/0323346 A1
(43) Pub. Date: Oct. 16, 2025

(54) COOLING PIPE AND BATTERY PACK INCLUDING THE SAME

(71) Applicants: HYUNDAI MOTOR COMPANY, Seoul (KR); Kia Corporation, Seoul (KR)

(72) Inventors: Gyung Hoon SHIN, Hwaseong-si (KR); Hae Woong JUNG, Hwaseong-si (KR)

(73) Assignees: HYUNDAI MOTOR COMPANY, Seoul (KR); Kia Corporation, Seoul (KR)

(21) Appl. No.: 19/025,186

(22) Filed: Jan. 16, 2025

(30) Foreign Application Priority Data
Apr. 16, 2024 (KR) 10-2024-0050902
Aug. 14, 2024 (KR) 10-2024-0109356

(51) Int. Cl. H01M 10/6552; H01M 10/613; H01M 10/617; H01M 10/653; H01M 10/658

(52) U.S. Cl. CPC H01M 10/6552; H01M 10/613; H01M 10/617; H01M 10/653; H01M 10/658

(57) ABSTRACT

A cooling pipe includes an inlet region, a pipe region including flow paths fluidically-communicating with the inlet region, and an outlet region configured to fluidically-communicate with the flow paths, in which the pipe region includes a main pipe region extending from the inlet region to the outlet region, and a plurality of branch pipe regions branching off from the main pipe region, and in which the main pipe region and the branch pipe regions are configured so that the fluid, which is introduced through the inlet region and flows in the main pipe region, is introduced into the branch pipe regions through first end portions of the branch pipe regions, and the fluid, which flows in the branch pipe regions, is discharged from the branch pipe regions through a second end portion of the branch pipe region.

### CROSS-REFERENCE TO RELATED APPLICATION

The present application claims priority to Korean Patent Application No. 10-2024-0050902 filed on Apr. 16, 2024, and Korean Patent Application No. 10-2024-0109356 filed on Aug. 14, 2024, the entire contents of which is incorporated herein for all purposes by this reference.

### BACKGROUND OF THE PRESENT DISCLOSURE

### Field of the Present Disclosure

The present disclosure relates to a cooling pipe and a battery pack including the same, and more particularly, to a cooling pipe, which includes a flow path through which a cooling fluid for cooling a battery in a battery pack flows, and a battery pack.

### Description of Related Art

A battery pack mounted in an electric vehicle needs to include a means for effectively cooling a battery. Methods of cooling the batteries may be classified into an air-cooled method and a water-cooled method depending on the types of fluids used to cool the batteries in the battery packs. Among these methods, the water-cooled method may have an excellent cooling effect and thus be applied to a battery pack mounted in a high-performance electric vehicle.

However, generally, there is a problem in that it is impossible to effectively cool the battery pack even though a relatively large amount of heat is generated in the battery pack mounted in the high-performance electric vehicle. Furthermore, generally, there is a problem in that a degree to which the battery is cooled greatly varies depending on a position of the battery in the battery pack when the battery pack is cooled.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a means configured for reducing a variation in a degree to which a battery in a battery pack is cooled depending on a position of the battery in the battery pack while effectively cooling the battery in the battery pack in comparison with the related art.

To achieve the above-mentioned object, one aspect of the present disclosure provides a cooling pipe including: an inlet region including an inlet through which a fluid is introduced; a pipe region including flow paths fluidically-communicating with the inlet region; and an outlet region including an outlet fluidically-communicating with the flow paths, wherein the fluid is discharged through the outlet, in which the pipe region includes: a main pipe region including a flow path extending from the inlet region to the outlet region; and a plurality of branch pipe regions including flow paths branching off from the main pipe region, and in which the main pipe region and the branch pipe regions are configured so that the fluid, which is introduced through the inlet region and flows in the main pipe region, is introduced into the branch pipe regions through first end portions of the branch pipe regions, and the fluid, which flows in the branch pipe regions, is discharged from the branch pipe regions through a second end portion of the branch pipe region.

The first end portions of the plurality of branch pipe regions may be spaced apart from one another in an extension direction of the main pipe region.

The pipe region may further include a merging pipe region including a flow path formed therein, the flow path being configured to fluidically-communicate with the flow path in the main pipe region through one end portion thereof, and at least some of the second end portions of the plurality of branch pipe regions may be connected to the merging pipe region.

Some of the remaining second end portions of the plurality of branch pipe regions may be directly connected to the main pipe region.

The plurality of branch pipe regions may be included in one of: a first branch pipe group including two or more branch pipe regions spaced apart from one another in a first direction D1; and a second branch pipe group including two or more branch pipe regions spaced apart from one another in a second direction D2 intersecting the first direction D1.

Based on a flow direction of the fluid introduced through the inlet region, the first end portion of the branch pipe regions in the first branch pipe group may be connected to an upstream region of the main pipe region in comparison with the first end portion of the branch pipe regions in the second branch pipe group.

Based on a flow direction of the fluid introduced through the inlet region, the second end portion of the branch pipe regions in the first branch pipe group may be connected to a downstream region of the main pipe region in comparison with the second end portion of the branch pipe regions in the second branch pipe group.

The second end portion of the branch pipe regions in the first branch pipe group may be directly connected to the main pipe region, and the second end portion of the branch pipe regions in the second branch pipe group may be connected to the merging pipe region.

The main pipe region may be provided to surround an external side of the first branch pipe group and an external side of the second branch pipe group.

The plurality of branch pipe regions may each include a shape extending in a zig-zag manner.

The main pipe region may include a zig-zag extension section including a shape extending in a zig-zag manner.

The zig-zag extension section may be provided at one side of the second branch pipe group based on the second direction D2.

The zig-zag extension section may correspond in shape and size to the branch pipe regions in the second branch pipe group.

Orifices may be formed in at least some of the plurality of branch pipe regions and each include a flow path narrower than a peripheral flow path.

The orifice may be formed at the first end portion or the second end portion of the branch pipe regions in the first branch pipe group.

The orifice may be formed in a section spaced apart from the first end portion and the second end portion of the branch pipe regions in the first branch pipe group.

Based on a flow direction of the fluid introduced through the inlet region, the number of orifices per unit length of the branch pipe regions in the first branch pipe group may increase as the first end portion of the branch pipe regions is connected to be closer to the inlet region.

The orifice may be formed only in a part of the branch pipe regions in the second branch pipe group.

Based on a flow direction of the fluid introduced through the inlet region, the first end portion of the branch pipe region, which includes the orifice among the branch pipe regions in the second branch pipe group, may be connected to an upstream region of the main pipe region in comparison with the first end portion of the branch pipe regions that does not include the orifice among the branch pipe regions in the second branch pipe group.

Based on a flow direction of the fluid flowing in the main pipe region through the inlet region, widths of the flow paths in the branch pipe regions may be narrowed toward the branch pipe regions including the first end portion provided to be closer to the inlet region.

To achieve the above-mentioned object, another aspect of the present disclosure provides a battery pack including: a battery module including a plurality of battery stacks disposed in a horizontal direction of the battery pack; and the cooling pipe mounted at one side of the battery module and configured to cool the battery module, in which the branch pipe regions of the cooling pipe are provided to face the plurality of battery stacks in the battery module in an upward and downward direction of the battery pack.

The cooling pipes may include: an upper cooling pipe mounted above the battery module; and a lower cooling pipe mounted below the battery module, and the branch pipe regions of the upper cooling pipe and the branch pipe regions of the lower cooling pipe may be provided to face the plurality of battery stacks in the battery module in the upward and downward direction of the battery pack.

The branch pipe regions of the cooling pipe may be provided to face the plurality of battery stacks in the battery module in the upward and downward direction in a one-to-one manner.

The battery pack may further include: a thermal insulation member mounted between the cooling pipe and the battery module, in which the thermal insulation member is mounted to face a partial section of the main pipe region in the upward and downward direction of the battery pack.

The thermal insulation member may be provided not to face the branch pipe region.

Based on a flow direction of the fluid introduced through the inlet region, a proportion of a portion of the main pipe region, which faces the thermal insulation member in an upstream region of the main pipe region, may be greater than a proportion of a portion of the main pipe region that faces the thermal insulation member in a midstream region of the main pipe region.

Based on a flow direction of the fluid introduced through the inlet region, a proportion of a portion of the main pipe region, which faces the thermal insulation member in a downstream region of the main pipe region, may be greater than a proportion of a portion of the main pipe region that faces the thermal insulation member in a midstream region of the main pipe region.

The battery module may be provided as a plurality of battery modules spaced apart from one another in the upward and downward direction, and the cooling pipes may be respectively mounted in space i) between the two battery modules mounted adjacent to each other in the upward and downward direction, space ii) above the battery module provided at an uppermost end portion among the plurality of battery modules, and space iii) below the battery module mounted at a lowermost end portion among the plurality of battery modules.

An average size of the flow paths formed in the cooling pipe mounted in space i) among the cooling pipes may be greater than an average size of the flow paths formed in the cooling pipe mounted in each of spaces ii) and iii) among the cooling pipes.

The inlet region, which is provided in one of the two cooling pipes mounted adjacent to each other in the upward and downward direction, and the outlet region, which is provided in the other of the two cooling pipes, may be provided to face each other in the upward and downward direction of the battery pack.

According to an exemplary embodiment of the present disclosure, it is possible to reduce a variation in the degree to which the battery in the battery pack is cooled depending on the position of the battery in the battery pack while effectively cooling the battery in the battery pack in comparison with the related art.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a perspective view of a battery pack according to an exemplary embodiment of the present disclosure.

FIG. 2 is an exploded perspective view exemplarily illustrating a stacked structure of the battery pack according to an exemplary embodiment of the present disclosure.

FIG. 3 is an enlarged view of a lower region in FIG. 2.

FIG. 4 is a perspective view exemplarily illustrating cooling pipes and hose members mounted in the battery pack according to an exemplary embodiment of the present disclosure.

FIG. 5 is a top plan view exemplarily illustrating one of the plurality of cooling pipes mounted in the battery pack according to an exemplary embodiment of the present disclosure.

FIG. 6 is an enlarged view of a branch pipe regions in a first branch pipe group among the cooling pipes illustrated in FIG. 5.

FIG. 7 is an enlarged view of a branch pipe regions in a second branch pipe group among the cooling pipes illustrated in FIG. 5.

FIG. 8 is a top plan view exemplarily illustrating another example of the cooling pipe mounted in the battery pack according to an exemplary embodiment of the present disclosure.

FIG. 9 is a top plan view exemplarily illustrating a state in which thermal insulation members are mounted at one side of the plurality of cooling pipes mounted in the battery pack according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, a battery pack according to an exemplary embodiment of the present disclosure will be described with reference to the drawings.

### Battery Pack

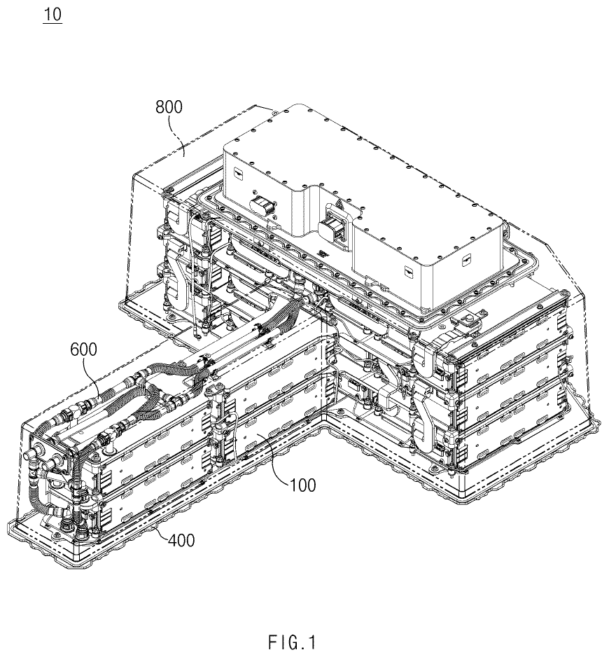

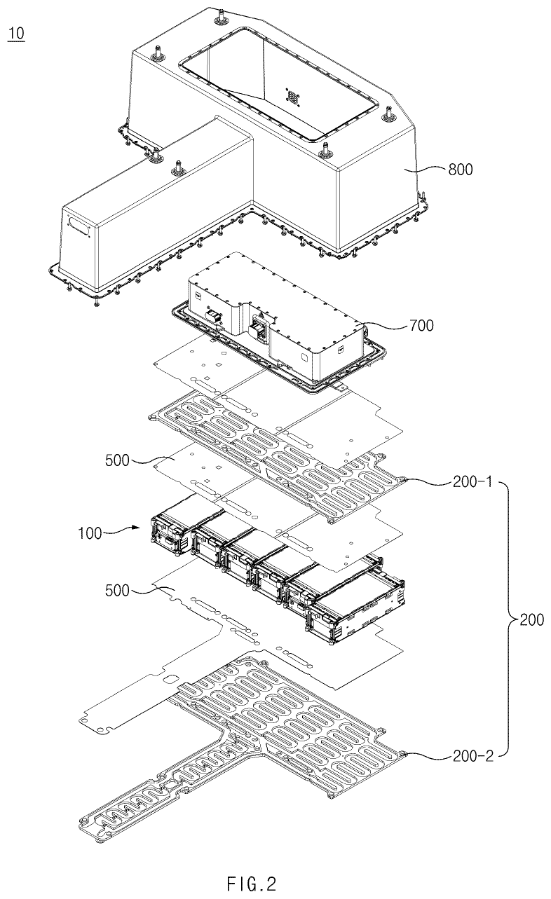

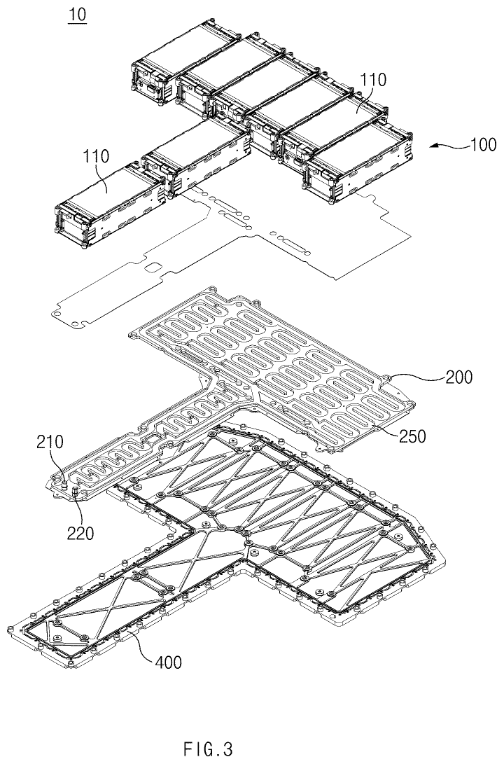

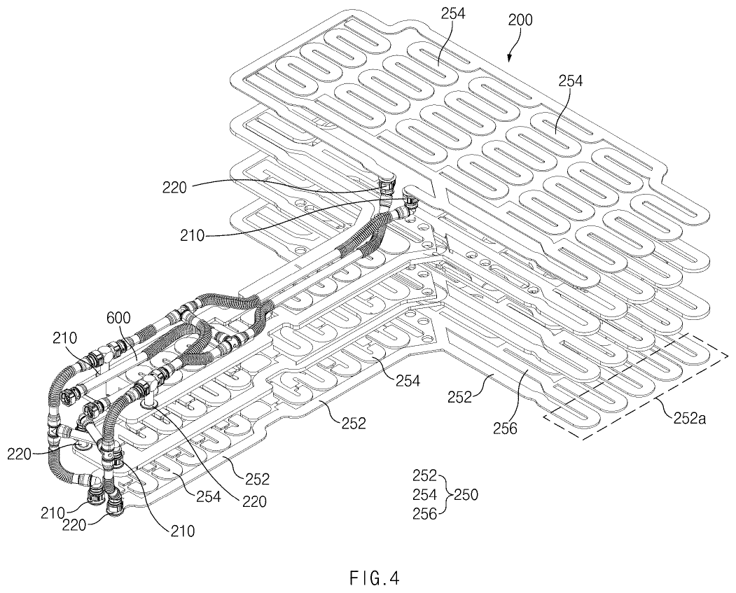

FIG. 1 is a perspective view of a battery pack according to an exemplary embodiment of the present disclosure, and FIG. 2 is an exploded perspective view exemplarily illustrating a stacked structure of the battery pack according to an exemplary embodiment of the present disclosure. FIG. 3 is an enlarged view of a lower region in FIG. 2, and FIG. 4 is a perspective view exemplarily illustrating cooling pipes and hose members provided in the battery pack according to an exemplary embodiment of the present disclosure.

With reference to FIG. 1, FIG. 2, FIG. 3, and FIG. 4, a battery pack 10 according to an exemplary embodiment of the present disclosure may include a battery module 100 including a plurality of battery stacks 110 disposed in a horizontal direction of the battery pack 10. The battery stack 110 may include a structure in which a plurality of batteries are stacked. For example, the above-mentioned battery may be a pouch-type battery. Alternatively, the battery may be a cylindrical battery or an angular battery.

Meanwhile, the battery pack 10 according to an exemplary embodiment of the present disclosure may include a configuration for cooling the battery module 100 by absorbing heat generated from the battery module 100, and discharging the generated heat to the outside of the battery pack 10. The battery pack 10 according to an exemplary embodiment of the present disclosure may further include cooling pipes 200 mounted at one side of the battery module 100 and configured to cool the battery module 100. A flow path may be formed in the cooling pipe 200, and a cooling fluid may flow along the formed flow path. The fluid may absorb thermal energy of the battery module 100 while flowing along the flow path of the cooling pipe 200, and the fluid may be discharged to the outside from the cooling pipe 200 so that the battery module 100 may be cooled by the fluid. As illustrated in FIG. 1, FIG. 2, and FIG. 3, the cooling pipes 200 may be mounted above and below the battery module 100 or above or below the battery module 100 and the cooling pipes 200 may be configured to receive thermal energy from the battery module 100 by thermal conduction therebetween. Meanwhile, a detailed shape of the cooling pipe 200 will be described below.

Meanwhile, the battery pack 10 according to an exemplary embodiment of the present disclosure may further include a base plate 400 mounted below the battery module 100. The battery module 100 may be in plural according to an exemplary embodiment of the present disclosure, and the plurality of battery modules 100 may be stacked in the battery pack 10 in an upward and downward direction of the battery pack 10. In the instant case, the base plate 400 may be mounted below the battery module 100 mounted at the lowermost end portion of the battery pack 10 among the plurality of battery modules 100. The base plate 400 is configured to support loads of the components of the battery pack 10 that include the battery module 100 and the cooling pipe 200.

Furthermore, the battery pack 10 according to an exemplary embodiment of the present disclosure may further include electrical insulation tapes 500 mounted between the battery modules 100 and the cooling pipes 200. For example, the electrical insulation tape 500 may be attached to each of the battery module 100 and the cooling pipe 200. The electrical insulation tape 500 may be configured to ensure electrical insulation between the battery module 100 and the cooling pipe 200. However, because the thermal conduction between the battery module 100 and the cooling pipe 200 needs to be ensured even in the instant case, the electrical insulation tape 500 may be made of a material having electrical insulation while having excellent thermal conduction.

Meanwhile, with reference to FIG. 1, FIG. 2, FIG. 3, and FIG. 4, the battery pack 10 according to an exemplary embodiment of the present disclosure may further include hose members 600 connected to the cooling pipes 200. The hose member 600 may include a flow path through which the cooling fluid for cooling the battery module 100 is supplied to the cooling pipe 200 and a flow path through which the fluid having flown through the cooling pipe 200 is discharged to the outside thereof. To the present end, the hose members 600 may be connected to a first side and a second side of each of the cooling pipes 200.

With reference to the drawings, the battery pack 10 according to an exemplary embodiment of the present disclosure may further include a power distribution unit (PDU) assembly 700 electrically connected to the plurality of battery modules 100. The PDU assembly 700 may serve to distribute electric power to a plurality of components in the battery module 100. Furthermore, the PDU assembly 700 may further include a relay member configured to perform control of turning on or off electric power, a fuse member configured to cut off electric power in an emergency situation, and a battery management system (BMS) configured to diagnose a state of the battery module 100 or a state of the battery stack 110 in the battery module 100. For example, as illustrated in the drawings, the PDU assembly 700 may be mounted to face an upper surface of the cooling pipe 200 mounted above the battery module 100 positioned at the uppermost end portion of the battery pack 10 among the plurality of battery modules 100.

Furthermore, the battery pack 10 according to an exemplary embodiment of the present disclosure may further include an upper cover member 800 defining a space for accommodating the battery module 100, the cooling pipes 200, the electrical insulation tapes 500, the hose members 600, and the like therein. The upper cover member 800, together with the base plate 400, may define an internal space of the battery pack 10 and may accommodate main components of the battery pack 10 and seal the internal space from the outside of the battery pack 10. A lower surface of the upper cover member 800 may be tightly attached and fixed to an upper surface of the base plate 400. Furthermore, a portion of an upper surface of the upper cover member 800 may include an opened region, and the PDU assembly 700 may be accommodated in the opened region.

Hereinafter, the cooling pipe 200 mounted in the battery pack 10 according to an exemplary embodiment of the present disclosure will be described in detail.

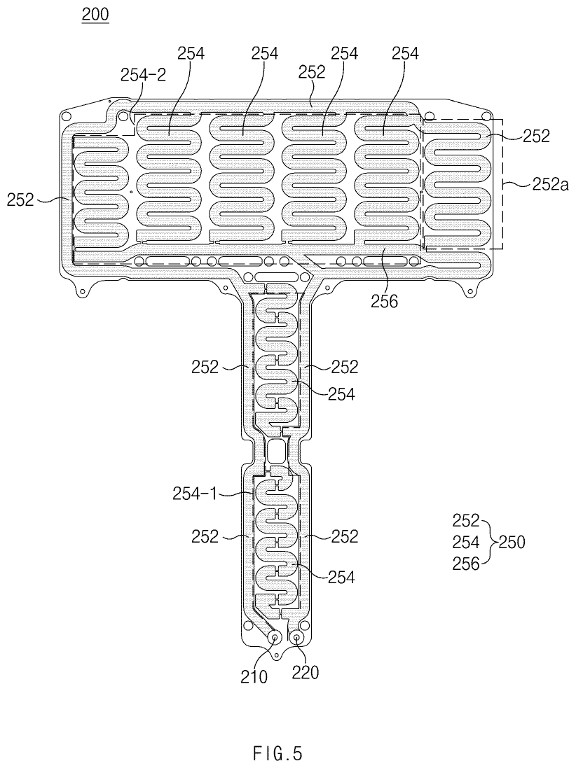

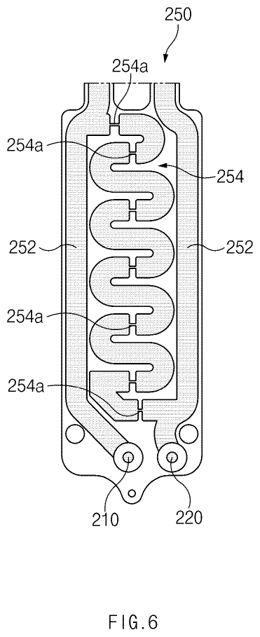

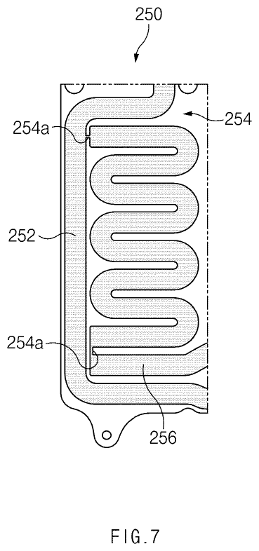

FIG. 5 is a top plan view exemplarily illustrating one of the plurality of cooling pipes mounted in the battery pack 10 according to an exemplary embodiment of the present disclosure, and FIG. 6 is an enlarged view of a branch pipe regions in a first branch pipe group among the cooling pipes illustrated in FIG. 5. FIG. 7 is an enlarged view of a branch pipe regions in a second branch pipe group among the cooling pipes illustrated in FIG. 5.

With reference to FIG. 5, FIG. 6 and FIG. 7, the cooling pipe 200 according to an exemplary embodiment of the present disclosure may include an inlet region 210 including an inlet through which the fluid is introduced. The inlet region 210 may be connected to one side of the hose member 600 (see FIG. 4 and the like), and the cooling fluid may be introduced into the cooling pipe 200 through the hose member 600. Furthermore, the cooling pipe 200 may further include an outlet region 220 including an outlet through which the fluid is discharged. The outlet region 220 may be connected to the other side of the hose member 600, and the cooling fluid having flown through the cooling pipe 200 may be discharged through the hose member 600. Furthermore, the cooling pipe 200 may further include a pipe region 250 including a flow path fluidically-communicating with the inlet region 210. In the instant case, the outlet region 220 may fluidically-communicate with the flow path of the pipe region 250. The pipe region 250 may define a route through which the fluid flows. The fluid, which flows through the pipe region 250, may absorb thermal energy from the battery module 100 mounted at one side of the cooling pipe 200.

Meanwhile, according to an exemplary embodiment of the present disclosure, the pipe region 250 of the cooling pipe 200 may be in plural. The plurality of pipe regions 250 may include a main pipe region 252 defining a flow path extending from the inlet region 210 to the outlet region 220, and a plurality of branch pipe regions 254 defining flow paths branching off from the main pipe region 252. In the instant case, according to an exemplary embodiment of the present disclosure, the main pipe region 252 and the branch pipe regions 254 may be configured so that the fluid, which is introduced into the inlet region 210 and flows through the main pipe region 252, is introduced into the branch pipe regions 254 through a first end portion of the branch pipe regions 254, and the fluid flowing through the branch pipe regions 254 is discharged from the branch pipe regions 254 through a second end portion of the branch pipe regions 254. That is, according to an exemplary embodiment of the present disclosure, the fluid flowing through the main pipe region 252 may be selectively introduced into one of the plurality of branch pipe regions 254.

Meanwhile, in the present specification, a portion of the branch pipe regions 254, which receives the fluid from the main pipe region 252, is defined as the first end portion of the branch pipe regions 254, and a portion of the branch pipe regions 254, through which the fluid having flown through the branch pipe regions 254 is discharged, is defined as the second end portion of the branch pipe regions 254. According to an exemplary embodiment of the present disclosure, it may be understood that the plurality of branch pipe regions 254 in the cooling pipe 200 are disposed in parallel with one another. The first end portion of the branch pipe regions 254 may be connected to one side of the main pipe region 252.

With reference to FIG. 5, FIG. 6 and FIG. 7, the first end portions of the plurality of branch pipe regions 254 may be spaced apart from one another in an extension direction of the main pipe region 252. It may be understood that the first end portions of the plurality of branch pipe regions 254 are provided in a flow direction of the fluid flowing through the main pipe region 252.

Meanwhile, the pipe region 250 may further include a merging pipe region 256 in addition to the main pipe region 252 and the branch pipe regions 254. The pipe region 250 may further include the merging pipe region 256 including a flow path formed therein, and the flow path may fluidically-communicate with the flow path in the main pipe region 252 through one end portion of the merging pipe region 256. The merging pipe region 256 may connect the branch pipe regions 254 and the main pipe region 252. At least some of the second end portions of the plurality of branch pipe regions 254 may be connected to the merging pipe region 256. Some of the second end portions of the plurality of branch pipe regions 254 may be connected to the merging pipe region 256, and some of the remaining second end portions of the plurality of branch pipe regions 254 may be directly connected to the main pipe region 252 without passing through the merging pipe region 256.

Meanwhile, some of the plurality of branch pipe regions 254 may be spaced apart from one another in a first direction D1, and some of the remaining branch pipe regions 254 may be spaced apart from one another in a second direction D2 intersecting the first direction D1. In the instant case, a group of two or more branch pipe regions 254 spaced apart from one another in the first direction D1 will be referred to as a first branch pipe group 254-1, and a group of two or more branch pipe regions 254 spaced apart from one another in the second direction D2 will be referred to as a second branch pipe group 254-2. In the instant case, the plurality of branch pipe regions 254 may be included in one of the first branch pipe group 254-1 and the second branch pipe group 254-2. For example, FIG. 5 illustrates a state in which two branch pipe regions 254 form the first branch pipe group 254-1, and five branch pipe regions 254 form the second branch pipe group 254-2. Both the first direction D1 and the second direction D2 may extend in the horizontal direction and be orthogonal to each other.

Meanwhile, based on the flow direction of the fluid introduced through the inlet region 210, the first end portion of the branch pipe regions 254 in the first branch pipe group 254-1 may be connected to an upstream region of the main pipe region 252 in comparison with the first end portion of the branch pipe regions 254 in the second branch pipe group 254-2. Therefore, among the fluids introduced into the main pipe region 252 through the inlet region 210, the fluid, which is not introduced into the branch pipe regions 254 in the first branch pipe group 254-1, may be introduced into the branch pipe regions 254 in the second branch pipe group 254-2. In contrast, based on the flow direction of the fluid introduced through the inlet region 210, the second end portion of the branch pipe regions 254 in the first branch pipe group 254-1 may be connected to a downstream region of the main pipe region 252 in comparison with the second end portion of the branch pipe regions 254 in the second branch pipe group 254-2. The second end portion of the branch pipe regions 254 in the first branch pipe group 254-1 may be directly connected to the main pipe region 252, and the second end portion of the branch pipe regions 254 in the second branch pipe group 254-2 may be directly connected to the merging pipe region 256.

Meanwhile, as illustrated in FIG. 4 and FIG. 5, according to an exemplary embodiment of the present disclosure, the main pipe region 252 may be provided to surround an external side of the first branch pipe group 254-1 and an external side of the second branch pipe group 254-2. It may be understood that the branch pipe regions in the first branch pipe group 254-1 and the branch pipe regions in the second branch pipe group 254-2 are disposed in a space defined and formed by the main pipe region 252.

According to an exemplary embodiment of the present disclosure, the plurality of branch pipe regions 254 may each include a shape having the flow path extending in a zig-zag manner. This may be to more effectively cool the battery module 100 by the cooling pipe 200 by increasing the length of the routes through which the fluid flows in the branch pipe regions 254 according to an exemplary embodiment of the present disclosure. The plurality of branch pipe regions 254 may each include a shape extending in a zig-zag manner. FIG. 4 and FIG. 5 illustrate states in which the plurality of branch pipe regions 254 provided in the cooling pipe according to an exemplary embodiment of the present disclosure each include a shape extending in a zig-zag manner. However, unlike the configurations illustrated in FIG. 4 and FIG. 5, some of the plurality of branch pipe regions 254 may not include the shape extending in the zig-zag manner. For example, the branch pipe regions in the first branch pipe group 254-1, which includes the first end portion disposed relatively adjacent to the inlet region 210, may include a shape extending in one direction, i.e., a direction toward the second branch pipe group 254-2. The branch pipe regions 254 in the first branch pipe group 254-1, which includes the first end portion disposed relatively adjacent to the inlet region 210, may be supplied with a relatively low-temperature cooling fluid. Therefore, the above-mentioned configuration may be provided to shorten the flow time of the cooling fluid flowing through the branch pipe regions 254 in the first branch pipe group 254-1 to prevent the vicinity of the first branch pipe group 254-1 from being overcooled and implement overall uniform cooling performance. For example, the branch pipe regions 254 in the first branch pipe group 254-1 may include a plurality of pipe lines extending in one direction, i.e., the direction toward the second branch pipe group 254-2 and disposed in parallel with one another.

Meanwhile, like the branch pipe regions 254, the main pipe region 252 may also include a section including a shape of flow path extending in a zig-zag manner. The main pipe region 252 may include a zig-zag extension section 252a extending in a zig-zag manner. In the instant case, the zig-zag extension section 252a may be provided at one side of the second branch pipe group 254-2 based on the second direction D2. It may be understood that a portion of a boundary of a space in which the second branch pipe group 254-2 is disposed is defined by the zig-zag extension section 252a.

As described above, the cooling pipe 200 may be mounted above or below the battery module 100. The branch pipe regions 254 and the zig-zag extension section 252a may be provided to face the battery stack 110 in the battery module 100 in the upward and downward direction of the battery pack 10. Therefore, the fluid may restore thermal energy from the battery module 100 while flowing through the branch pipe regions 254 and the zig-zag extension section 252a.

Therefore, the zig-zag extension section 252a may be similar in shape and size to the branch pipe regions 254. The zig-zag extension section 252a may correspond in shape and size to the branch pipe regions 254 in the second branch pipe group 254-2. In the instant case, the configuration in which the two components correspond in shape and size to each other needs to be interpreted as including a case in which the two components are geometrically similar in shape and size to each other to the extent that the two components exhibit substantially the same function when glancing at the two components even though the two components are completely identical in shape to each other.

Meanwhile, according to an exemplary embodiment of the present disclosure, a means for reducing a deviation of a flow rate of the fluid introduced into the plurality of branch pipe regions 254 may be provided additionally. Orifices 254a may be formed in at least some of the plurality of branch pipe regions 254 and each include a flow path narrower than the flow path near to the orifices 254a. The orifice 254a may reduce the deviation of the flow rate between the plurality of branch pipe regions 254 by increasing overall flow resistance of the branch pipe regions 254, into which the fluid may be introduced at a relatively high flow rate, among the plurality of branch pipe regions 254.

Meanwhile, because the first end portion of the branch pipe regions 254 in the first branch pipe group 254-1 may be connected to the relatively upstream region of the main pipe region 252 in comparison with the first end portion of the branch pipe regions 254 in the second branch pipe group 254-2 as described above, a relatively large amount of fluid may be introduced into the branch pipe regions 254 in the first branch pipe group 254-1. Therefore, the orifice 254a may be formed in the branch pipe regions 254 in the first branch pipe group 254-1. With reference to FIG. 6 and FIG. 7, the orifices 254a may be in plural. Some of the plurality of orifices 254a may be formed at the first end portion or the second end portion of the branch pipe regions 254 in the first branch pipe group 254-1. Some of the remaining orifices 254a may be formed in a section spaced apart from the first end portion and the second end portion of the branch pipe regions 254 in the first branch pipe group 254-1. For example, as illustrated in FIG. 6, the orifices 254a may be respectively formed at the first end portion and the second end portion of the branch pipe regions 254 in the first branch pipe group 254-1, and five orifices 254a may be formed in the section spaced apart from the first end portion and the second end thereof. However, the number of orifices 254a is not limited to the number of orifices 254a illustrated in the drawings.

Meanwhile, a relatively large number of orifices 254a need to be formed in the branch pipe regions 254 connected to the relatively upstream region of the main pipe region 252 among the branch pipe regions 254 in the first branch pipe group 254-1. Therefore, according to an exemplary embodiment of the present disclosure, in the branch pipe regions 254 in the first branch pipe group 254-1, the number of orifices 254a per unit length of the branch pipe regions 254 may increase as the first end portion is connected to be closer to the inlet region 210 (i.e., the first end portion is connected to the upstream region of the main pipe region).

In contrast, unlike the first branch pipe group 254-1, the number of orifices 254a may be relatively small in the second branch pipe group 254-2. The orifice 254a may be formed only in a portion of the branch pipe regions 254 in the second branch pipe group 254-2. For example, with reference to FIG. 5 and FIG. 7, among the branch pipe regions 254 in the second branch pipe group 254-2, the orifice 254a may be provided only in the branch pipe regions 254 including the first end portion connected to the upstream region of the main pipe region 252 based on the flow direction of the fluid. That is, the first end portion of the branch pipe regions 254, which includes the orifice 254a among the branch pipe regions 254 in the second branch pipe group 254-2, may be connected to the upstream region of the main pipe region 252, based on the flow direction of the fluid introduced through the inlet region 210, in comparison with the first end portion of the branch pipe regions 254 that does not include the orifice 254a among the branch pipe regions 254 in the second branch pipe group 254-2.

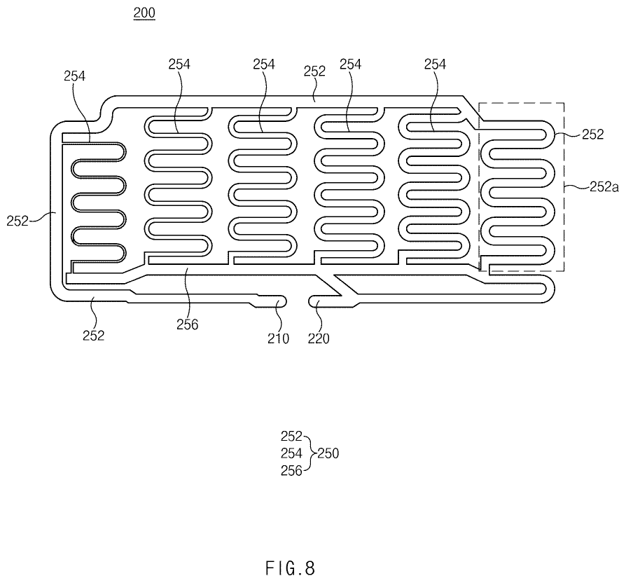

FIG. 8 is a top plan view exemplarily illustrating another example of the cooling pipe mounted in the battery pack according to an exemplary embodiment of the present disclosure.

The cooling pipe 200 according to another example illustrated in FIG. 8 differs from the above-mentioned cooling pipe 200 in that widths of overall flow paths of the branch pipe regions 254 are different from one another. However, the other contents, except for the difference, may be equally applied to the cooling pipe 200 according to another example.

With reference to FIG. 8, in the cooling pipe 200 according to another example, based on the flow direction of the fluid flowing along the main pipe region 252 through the inlet region 210, the widths of the flow paths in the branch pipe regions 254 may be narrowed toward the branch pipe regions 254 including the first end portion provided to be closer to the inlet region 210. This may be to reduce the deviation of the flow rate of the fluid between the plurality of branch pipe regions 254 by preventing the fluid from being introduced at a high flow rate into the branch pipe regions 254 including the first end portion connected to the upstream region of the main pipe region 252.

Meanwhile, as described above, in the battery pack 10 according to an exemplary embodiment of the present disclosure, the branch pipe regions 254 of the cooling pipe 200 may be provided to face the plurality of battery stacks 110 in the battery module 100 in the upward and downward direction of the battery pack 10. The branch pipe regions 254 of the cooling pipe 200 may be disposed to face the plurality of battery stacks 110 in the battery module 100 in the upward and downward direction in a one-to-one manner. Furthermore, according to an exemplary embodiment of the present disclosure, the cooling pipes 200 may be mounted above and below the battery module 100. As illustrated in FIG. 4, the cooling pipes 200 may include an upper cooling pipe 200-1 mounted above the battery module 100, and a lower cooling pipe 200-2 mounted below the battery module 100. The branch pipe regions 254 (see FIG. 5 and the like) of the upper cooling pipe 200-1 and the branch pipe regions 254 of the lower cooling pipe 200-2 may be provided to face the plurality of battery stacks 110 in the battery module 100 in the upward and downward direction of the battery pack 10.

Meanwhile, with reference to FIG. 1, FIG. 2, and FIG. 3, in the battery pack 10 according to an exemplary embodiment of the present disclosure, the battery modules 100 may be provided as a plurality of battery modules 100 spaced apart from one another in the upward and downward direction of the battery pack 10. In the instant case, the cooling pipes 200 may be respectively mounted in space i) between the two battery modules 100 mounted adjacent to each other in the upward and downward direction, space ii) above the battery module 100 mounted at the uppermost end portion among the plurality of battery modules 100, and space iii) below the battery module 100 mounted at the lowermost end portion among the plurality of battery modules 100. In the instant case, the battery module 100 may be cooled by the cooling pipe 200 mounted above the battery module and the cooling pipe 200 mounted below the battery module. However, the cooling pipes 200, which are disposed at the uppermost end portion and the lowermost end portion among the cooling pipes 200, only need to cool the battery module 100 mounted below the cooling pipe 200 and cool the battery module 100 mounted above the cooling pipe 200, whereas the cooling pipe 200 mounted between the two battery modules 100, which are adjacent to each other in the upward and downward direction, needs to cool all the battery modules 100 mounted above and below the cooling pipe. Therefore, a flow rate of the cooling fluid in the cooling pipe 200 mounted in space i) needs to be higher than a flow rate of the cooling fluid in the cooling pipe 200 mounted in each of spaces ii) and iii). Therefore, according to an exemplary embodiment of the present disclosure, an average size of the flow paths formed in the cooling pipe mounted in space i) among the cooling pipes 200 may be greater than an average size of the flow paths formed in the cooling pipe mounted in each of spaces ii) and iii) among the cooling pipes. For example, the average size of the flow paths formed in the cooling pipe mounted in space i) may be 1.5 or more times greater than an average size of the flow paths formed in the cooling pipe mounted in each of spaces ii) and iii) among the cooling pipes.

Furthermore, with reference to FIG. 4, according to an exemplary embodiment of the present disclosure, the inlet regions 210 and the outlet regions 220 of the two cooling pipes 200 mounted adjacent to each other in the upward and downward direction may be provided to intersect each other. The inlet region 210, which is provided in one of the two cooling pipes 200 mounted adjacent to each other in the upward and downward direction, and the outlet region 220, which is provided in the other of the two cooling pipes 200, may be provided to face each other in the upward and downward direction of the battery pack 10.

Therefore, according to an exemplary embodiment of the present disclosure, the flow direction of the fluid, which flows along the cooling pipe 200 mounted above the battery module 100, and the flow direction of the fluid, which flows along the cooling pipe 200 mounted below the battery module 100, may be opposite to each other. Therefore, according to an exemplary embodiment of the present disclosure, it is possible to reduce a cooling deviation between the battery stacks 110 in the battery module 100.

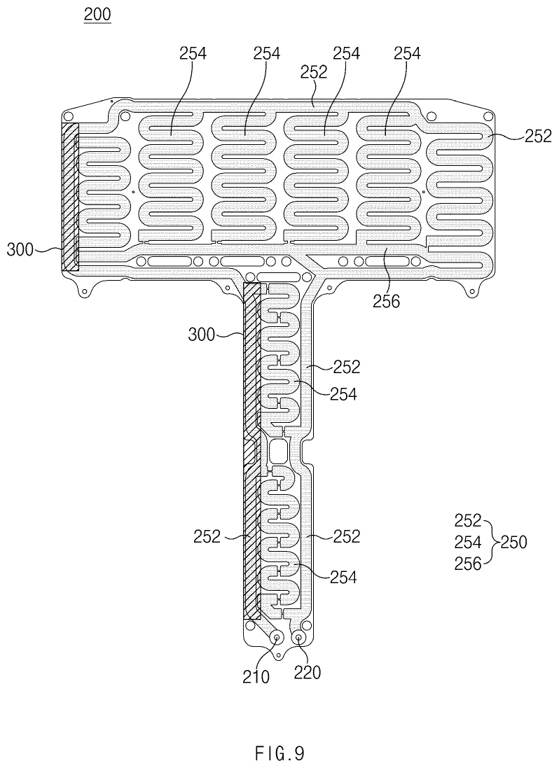

FIG. 9 is a top plan view exemplarily illustrating a state in which thermal insulation members are mounted at one side of the plurality of cooling pipes mounted in the battery pack according to an exemplary embodiment of the present disclosure.

Meanwhile, with reference to FIG. 9, the battery pack 10 according to an exemplary embodiment of the present disclosure may further include thermal insulation members 300 mounted between the cooling pipe 200 and the battery module 100. The thermal insulation member 300 may be a component mounted separately from the insulation tape 500 and be configured to further reduce the cooling deviation between the battery stacks 110 in the battery module 100. The thermal insulation member 300 may be configured to suppress heat-exchange between the fluid and the battery stack 110 which may be relatively significantly cooled by the fluid in the battery module 100 or rather heated by the fluid.

As illustrated in FIG. 9, the thermal insulation member 300 may be mounted to face a partial section of the main pipe region 252 in the upward and downward direction but may not face the branch pipe regions 254. This may be not to hinder direct heat-exchange between the fluid in the branch pipe regions 254 and the battery stack 110. For example, the thermal insulation member 300 may be a tape member. The thermal insulation members 300 may be respectively attached to the battery module 100 and the main pipe region 252.

As described above, the thermal insulation member 300 may be configured to suppress heat-exchange between the fluid and the battery stack 110 which may be relatively significantly cooled by the fluid in the battery module 100 or rather heated by the fluid. In the instant case, the battery stack 110, which may be cooled relatively significantly by the fluid in the battery module 100, may be disposed adjacent to the upstream region of the main pipe region 252 based on the flow direction of the fluid, and the battery stack 110, which may be rather heated by the fluid in the battery module 100, may be disposed adjacent to the downstream region of the main pipe region 252 based on the flow direction of the fluid. Therefore, according to an exemplary embodiment of the present disclosure, based on the flow direction of the fluid introduced through the inlet region 210, a proportion of the portion of the main pipe region 252, which faces the thermal insulation member 300 in the upstream region of the main pipe region 252, may be greater than a proportion of the portion of the main pipe region 252 that faces the thermal insulation member 300 in a midstream region of the main pipe region 252. A proportion of the portion of the main pipe region 252, which faces the thermal insulation member 300 in the downstream region of the main pipe region 252, may be greater than a proportion of the portion of the main pipe region 252 that faces the thermal insulation member 300 in the midstream region of the main pipe region 252.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “or” used in an exemplary embodiment of the present disclosure should be interpreted as indicating “additionally or alternatively.”

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

The terms used to describe the exemplary embodiments are used for describing predetermined embodiments, and are not intended to limit the embodiments. As used in the description of the exemplary embodiments and in the claims, the singular forms “a”, “an”, and “the” include plural referents unless the context clearly dictates otherwise. The expression “and/or” is used to include all possible combinations of terms.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

As used herein, conditional expressions such as “if” and “when” are not limited to an optional case and are intended to be interpreted, when a specific condition is satisfied, to perform the related operation or interpret the related definition according to the specific condition.

Terms such as first and second may be used to describe various elements of the embodiments. However, various components according to the exemplary embodiments should not be limited by the above terms. These terms are only used to distinguish one element from another.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A cooling pipe comprising:
an inlet region including an inlet through which a fluid is introduced;
a pipe region including flow paths fluidically-communicating with the inlet region; and
an outlet region including an outlet fluidically-communicating with the flow paths, the fluid discharged through the outlet,
wherein the pipe region includes:
a main pipe region including a flow path extending from the inlet region to the outlet region; and
a plurality of branch pipe regions including flow paths branching off from the main pipe region, and
wherein the fluid, which is introduced through the inlet region and flows in the main pipe region, is introduced into the branch pipe regions through a first end portion of the branch pipe regions, and the fluid, which flows in the branch pipe regions, is discharged from the branch pipe regions through a second end portion of the branch pipe regions.

2. The cooling pipe of claim 1, wherein the first end portions of the plurality of branch pipe regions are spaced apart from one another in an extension direction of the main pipe region.

3. The cooling pipe of claim 2,
wherein the pipe region further includes a merging pipe region including a flow path formed therein, the flow path of the merging pipe region fluidically-communicating with the flow path of the main pipe region through one end portion of the merging pipe region, and
wherein at least some of the second end portions of the plurality of branch pipe regions are connected to the merging pipe region.

4. The cooling pipe of claim 3, wherein some of remaining second end portions of the plurality of branch pipe regions are directly connected to the main pipe region.

5. The cooling pipe of claim 3, wherein the plurality of branch pipe regions is included in one of:
a first branch pipe group including two or more branch pipe regions spaced apart from one another in a first direction; and
a second branch pipe group including two or more branch pipe regions spaced apart from one another in a second direction intersecting the first direction.

6. The cooling pipe of claim 5, wherein based on a flow direction of the fluid introduced through the inlet region, the first end portion of the branch pipe regions in the first branch pipe group is connected to an upstream region of the main pipe region in comparison with the first end portion of the branch pipe regions in the second branch pipe group.

7. The cooling pipe of claim 5, wherein based on a flow direction of the fluid introduced through the inlet region, the second end portion of the branch pipe regions in the first branch pipe group is connected to a downstream region of the main pipe region in comparison with the second end portion of the branch pipe regions in the second branch pipe group.

8. The cooling pipe of claim 7, wherein the second end portion of the branch pipe regions in the first branch pipe group is directly connected to the main pipe region, and the second end portion of the branch pipe regions in the second branch pipe group is connected to the merging pipe region.

9. The cooling pipe of claim 5, wherein the main pipe region is provided to surround an external side of the first branch pipe group and an external side of the second branch pipe group.

10. The cooling pipe of claim 9, wherein the plurality of branch pipe regions each includes a shape extending in a zig-zag manner.

11. The cooling pipe of claim 5, wherein the main pipe region includes a zig-zag extension section including a shape extending in a zig-zag manner.

12. The cooling pipe of claim 11, wherein the zig-zag extension section is provided at one side of the second branch pipe group based on the second direction.

13. The cooling pipe of claim 12, wherein the zig-zag extension section corresponds in shape and size to the branch pipe regions in the second branch pipe group.

14. The cooling pipe of claim 5, wherein at least one orifice are formed in at least some of the plurality of branch pipe regions and each thereof include a flow path narrower than a flow path near to the orifices.

15. The cooling pipe of claim 14, wherein the at least one orifice is formed at the first end portion or the second end portion of the branch pipe regions in the first branch pipe group.

16. The cooling pipe of claim 14, wherein the at least one orifice is formed in a section spaced apart from the first end portion and the second end portion of the branch pipe regions in the first branch pipe group.

17. The cooling pipe of claim 16, wherein based on a flow direction of the fluid introduced through the inlet region, a number of orifices per unit length of the branch pipe regions in the first branch pipe group increases as the first end portion of the branch pipe regions is connected to be closer to the inlet region.

18. The cooling pipe of claim 14, wherein the at least one orifice is formed only in a portion of the branch pipe regions in the second branch pipe group.

19. The cooling pipe of claim 18, wherein based on a flow direction of the fluid introduced through the inlet region, the first end portion of the branch pipe region, which includes the at least one orifice among the branch pipe regions in the second branch pipe group, is connected to an upstream region of the main pipe region in comparison with the first end portion of the branch pipe regions that does not include the at least one orifice among the branch pipe regions in the second branch pipe group.

20. The cooling pipe of claim 1, wherein based on a flow direction of the fluid flowing in the main pipe region through the inlet region, widths of the flow paths in the branch pipe regions are narrowed toward the branch pipe regions including the first end portion provided to be closer to the inlet region.
